(19) United States
(12) Patent Application Publication
(10) Pub. No.: US 2012/0234152 A1
(43) Pub. Date: Sep. 20, 2012

(54) CUTTING UNIT FOR LABELLING MACHINES WITH A MULTIPLE-BLADE ROTARY DRUM

(76) Inventor: James Carmichael, Parma (IT)

(21) Appl. No.: 13/387,438

(22) PCT Filed: Jul. 29, 2009
(86) PCT No.: PCT/IB2009/053297

§ 371 Date: Jun. 1, 2012

(51) Int. Cl. B26D 7/26; B26D 1/20

(52) U.S. Cl. 83/677

(57) ABSTRACT

Cutting unit for labelling machines having a multiple-blade rotary drum, particularly of the type that use a label reel from which the labels are cut and applied on objects, namely on containers, are provided. In particular, cutting units for cutting labels from a label film in labelling machines, comprising a rotary blade drum having at least one blade and a stationary blade assembly having a counter-blade, said rotary blade drum comprising at least one blade support carrying a blade, characterised in that said at least one blade support comprises a plurality of independently-operated actuator means, said actuators being positioned along the blade support for adjusting said blade, this adjustment being performed by raising or lowering corresponding portions of the blade through elastic deformation.

The present invention relates to a cutting unit for labelling machines having a multiple-blade rotary drum, particularly of the type that use a label reel from which the labels are cut and applied on objects, namely on containers.

In these machines, generally known as roll fed labelling machines, the containers are carried by a carrousel and come into contact with a labelling unit. The labelling unit comprises a motorized path wherein at least one feeding roll moves the label strip from a label reel to the carrousel, through a cutting unit, for cutting at the appropriate length the label from the label strip which is moved by the feeding roll, and a so called “vacuum drum” that receives the cut labels and finally transfers the labels to the objects (the containers or the mandrels in a sleeve-type labelling machine) in the carrousel.

The cutting unit comprises a rotary blade and a stationary blade, also known as the counterblade, that are positioned adjacent to the vacuum drum. The label film passes between the stationary and the rotary blade of the cutting unit while the film end is retained by suction on the vacuum drum. This latter rotates at a speed that is higher than the speed at which the label film is fed, thus the vacuum drum exerts a pulling force on the film end. When the rotary blade comes into contraposition with the stationary blade, the label film passing therebetween is cut. Typically, the stationary blade and the rotary blade contacts with substantially no interference, so that the label film, which is a thin plastic film, is greatly weakened along the cutting line and the label is separated by the pulling force applied by the vacuum drum. The label length is determined by the speed at which the label film is fed, the faster the film the longer the label, as well as by the speed and the dimension of the rotary blade drum.

Conventional rotary blade drums comprise only one blade disposed at the periphery thereof, however this configuration strongly limits the range of label lengths that can be cut by this cutting unit, for the reasons set forth above.

More recently, rotary blade drums have been proposed wherein more than one blade, typically two blades are provided. This cutting unit allows to cut labels in a wide range of lengths, particularly short labels as only half a revolution of the drum is necessary for the contraposition of the rotary blade with the stationary blade, but this arrangement raises substantial setup and adjustment problems. The result is that, in these systems, the cutter blades must be regulated each time they are replaced.

As these blades have the shape of a bar, they may present some irregularities or defects, so that their cutting edge can be not perfectly straight. Therefore, the adjustment of the blade must be punctual, i.e. it must be made on a point-by-point basis along the entire length of the blade. This makes the said regulation particularly complicate and lengthy.

It is therefore an object of the present invention to provide a rotary blade drum and a cutting unit for a labelling machine containing it that overcomes the above problem of fine adjustment of the blade.

This object is achieved by a cutting unit as defined in the appended claims whose definitions are integral part of the present description.

In a general embodiment, the present invention relates to a cutting unit 1 for cutting labels 5 from a label film 6 in labelling machines, comprising a rotary blade drum 2 having at least one blade 7a, 7b and a stationary blade assembly 3 having a counter-blade 8, that the said rotary blade drum 2 comprising at least one blade support 10a, 10b carrying a blade 7a, 7b, characterised in the said at least one blade support 10a, 10b comprises a plurality of independently-operated actuator means 19 positioned along the entire length of the blade support 10a, 10b and providing for a punctual adjustment of the blade 7a, 7b, this adjustment being performed by raising or lowering corresponding portions of the blade 7a, 7b through elastic deformation. The actuator means 19 are designed to apply a raising force on a base portion of the said blade 7a, 7b.

Further features and advantages of the present invention will be better understood from the description of preferred embodiments, which are given below by way of a non-limiting illustration, with reference to the following figures:

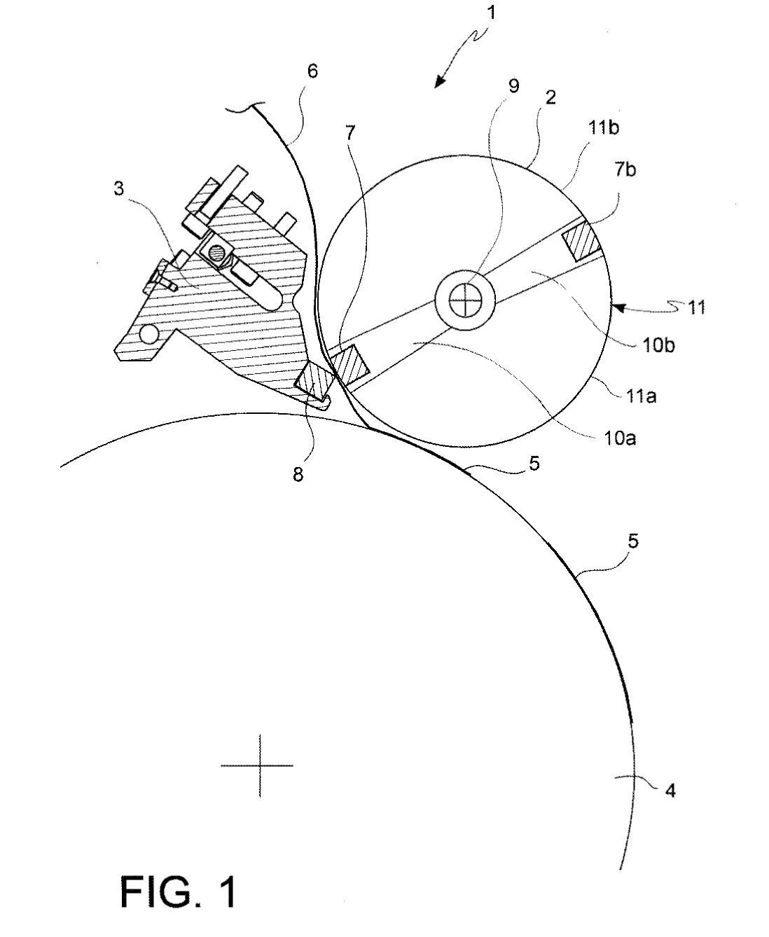

FIG. 1 shows a schematic top view of the cutting unit of the invention;

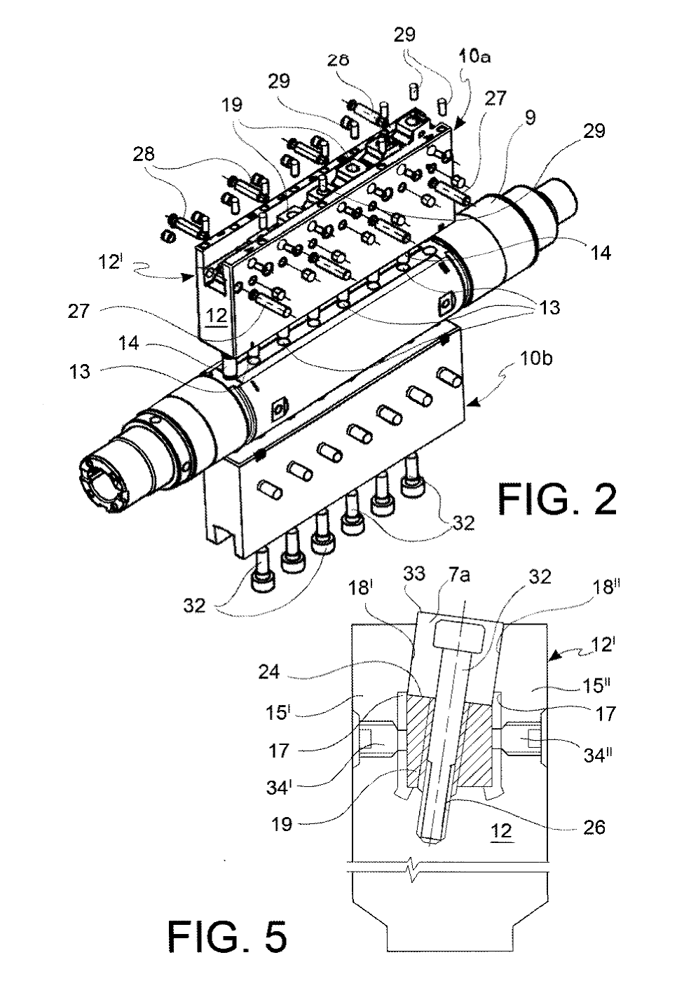

FIG. 2 shows a perspective exploded view of the rotary blade assembly of the invention;

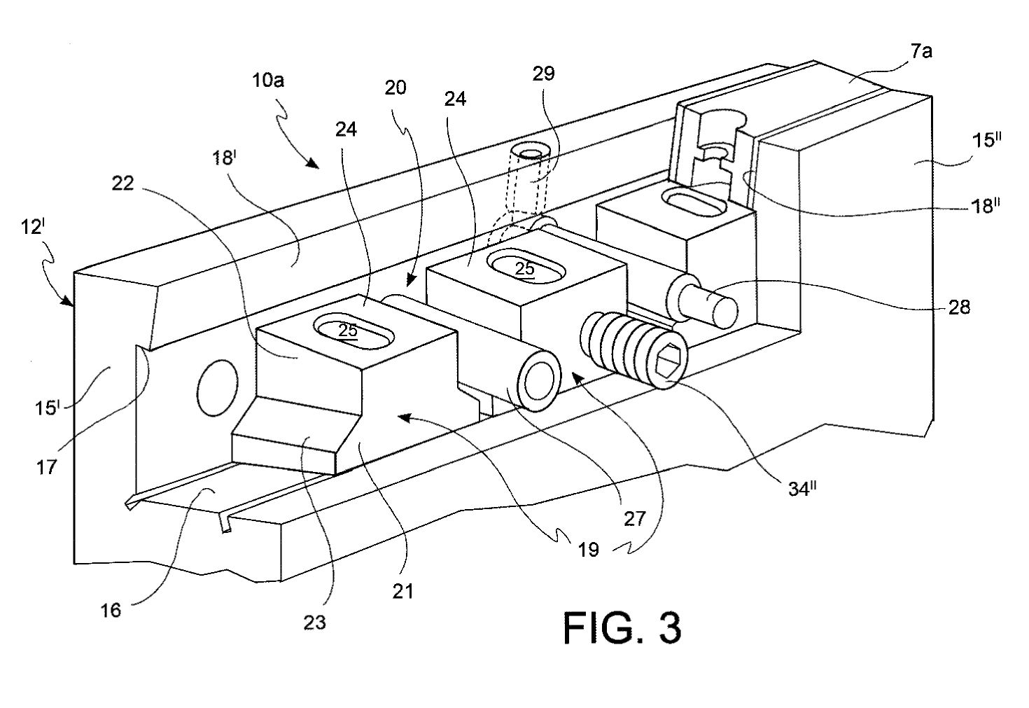

FIG. 3 shows a perspective partially sectioned view of a particular of FIG. 1;

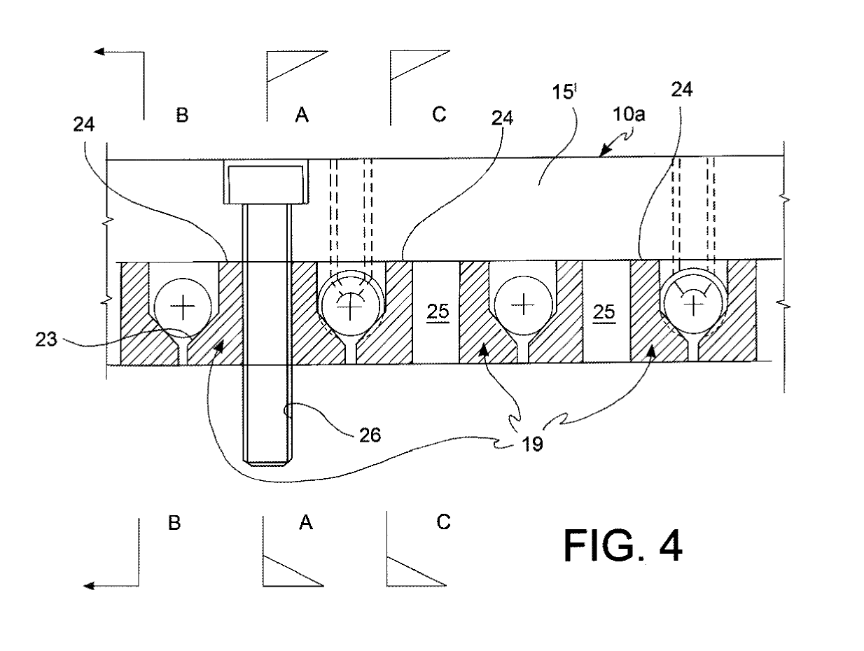

FIG. 4 shows a sectioned side view of a particular of FIG. 1;

FIG. 5 shows a sectional view along the direction A-A of FIG. 3;

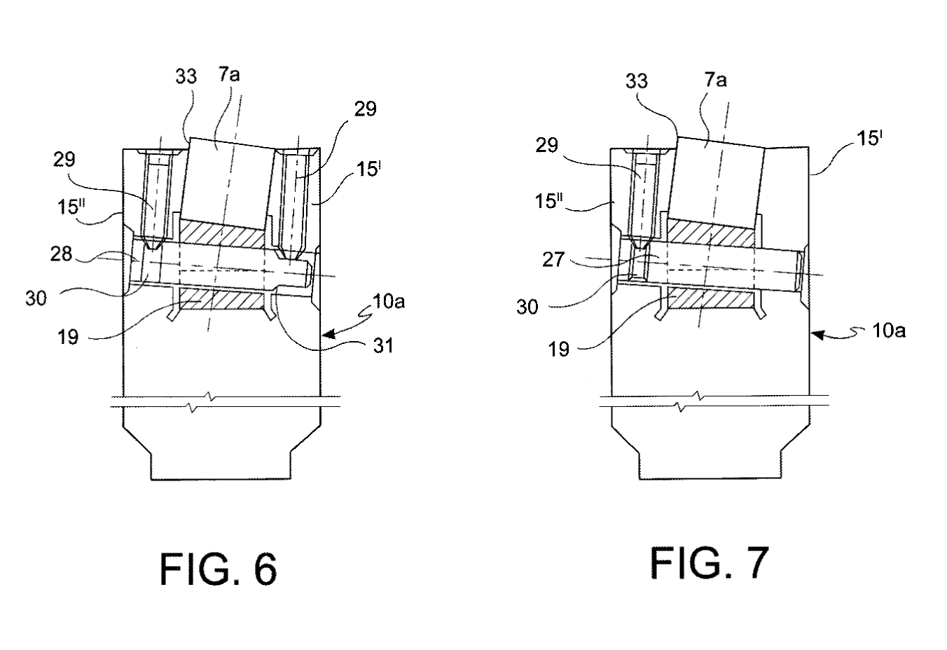

FIG. 6 shows a sectional view along the direction C-C of FIG. 3;

FIG. 7 shows a sectional view along the direction B-B of FIG. 3.

With reference to the figures, the cutting unit, indicated as a whole with the numeral 1, comprises a rotary blade drum 2, having two blades 7a, 7b, and a stationary blade assembly 3, having a counter-blade 8, and is positioned adjacent to a vacuum drum 4 so that a label 5—that is cut from a label film 6—is transferred to the vacuum drum. Typically, the vacuum drum 4 engages by suction the end of the label film 6 before the cutting unit cuts the label 5, so that a pulling force is applied to the label film 6 end to facilitate the separation of the label 5 from the film.

The rotary blade drum 2 comprises a rotary shaft 9, that is connected to motor means (not shown), to which shaft 9 two blade supports 10a, 10b are radially mounted, so that the said blades 7a, 7b are positioned along the periphery of the rotary blade drum 2, at opposed ends of a diameter of the drum.

The rotary blade drum 2 also comprises a casing 11 consisting of two half cylinders 11a, 11b that are secured at both sides of the blade supports 10a, 10b without covering the ends thereof, so that the blades 7a, 7b are exposed to the exterior. The casing 11 is normally made of plastic material, but it may also be metallic.

As the two blade supports 10a,10b may be totally identical, only the blade support 10a will be described herein below, the same description applying also for the blade support 10b. Moreover, in one embodiment, only one blade support 10a can be regulated as described below, the other support 10b being a conventional blade support. In this embodiment, the adjustable blade support 10a will be adjusted to match by symmetry of the second blade support 10b profile.

The blade support 10a has a substantially parallelepiped body 12 developing along a main axis, the bottom of which presents a plurality of blind and through holes, aligned with respective holes 13 in the rotary shaft 9, so that securing bolts and a plurality of alignment pins 14 can be inserted therein to fix the blade support 10a to the rotary shaft 9.

The top end 12′ of the body 12 is substantially C-shaped, so that to form a longitudinal groove 20. The groove 20 presents two sides 15′, 15″ and a bottom 16. Both the sides 15′, 15″ comprise an undercut 17 and present, at the side portion between such undercut 17 and the edges of the sides 15′, 15″, slightly inclined surfaces 18′, 18″ with respect to the vertical. These inclined surfaces 18′, 18″ are substantially parallel.

A plurality of actuator means 19 are positioned in a sliding arrangement along a transversal direction on the bottom 16 of the longitudinal groove 20.

In the embodiment shown in the figures, the actuator means 19 are wedge means. This actuator means 19 has a substantially T-shaped section and comprises a base portion 21 and a top portion 22 that is narrower than the base portion 21, so that a shoulder 23 is formed. The shoulder 23 forms an inclined plane joining the top portion 22 to the base portion 21.

The width of the actuator means 19 is less than the width of the longitudinal groove 20, so that they can slide transversally with respect to the main axis of the groove 20.

The actuator means 19 are positioned side-by-side in the groove 20, in such a way that the base portions 21 thereof are in touch or are very close to each other, while the top portions 22 are distanced. In other words, the plane wherein the T-section lies coincides or is parallel to the longitudinal vertical plane of the longitudinal groove 20.

The top portion 22 of the actuator means 19 has an upper surface 24 which is slightly inclined on a plane that forms with the longitudinal vertical plane of the groove 20, a predefined angle of incidence different from 90°, the said angle defining the inclination of said upper surface 24.

In an embodiment, the said upper surface 24 forms with the said inclined surfaces 18′, 18″ of the sides 15′, 15″, respectively, angles of about 90°.

A slot-shaped through hole 25 passes the actuator means 19 body from the top to the bottom and is aligned with a blind hole 26 made in the bottom 16 of the groove 20. The axis of the said slot-shaped through hole 25 is substantially perpendicular to the upper surface 24 of the actuator means 19.

A plurality of pins 27, 28 is positioned in the longitudinal groove 20 and transversally cross it between one actuator means 19 and the other, at a height such as to engage the surface of the shoulder 23 of two adjacent actuator means 19. The function of such pins 27, 28 is to keep the actuator means 19 pressed with a predefined strength against the bottom 16 of the groove 20. They act as retaining means when the wedges are machined !in kit” with the assembly, and as guide bars when the wedges are adjusted.

To facilitate mounting and dismounting, fixed pins 27 and floating pins 28 are positioned in an alternate manner. The pins 27, 28 are inserted in corresponding through holes in both sides 15′, 15″ and are fixed with a predefined strength by means of pressing means 29, such as pressure screws, that are provided in corresponding holes of the sides 15′, 15″ of the groove 20, substantially perpendicular to the axis of the pins 27, 28. As shown in FIGS. 6 and 7, only one pressing means 29 hold in position the fixed pins 27, while two pressing means 29, one at both sides 15′, 15″, is used for the floating pins 28. At the point wherein the pressing means 29 engage the pins 27, 28, these latter are suitably shaped to present an annular groove 30 or a shoulder 31 to longitudinally hold the pins 27, 28 in their respective positions.

With reference to FIG. 5, when the said actuator means 19 are positioned in the groove 20 as described above, a blade 7a, typically a bar-like blade, can be laid thereon and can be hold by a plurality of fixing means 32, such as screws, that pass through the body of the blade 7a and the slot-shaped through holes 25 of the actuator means 19 and engage the threaded blind hole 26 in the bottom 16 of the groove 20. The said fixing means are subject to a predetermined torque, so that the mounting of the piece is kept in the predefined tolerance levels.

As the upper surface 24 of the actuator means 19 is inclined, also the blade 7a, that has normally a square or a rectangular section, is hold in inclined position, so that the cutting edge 33 of the blade 7a is protruding.

Adjusting means 34′, 34″, such as adjusting screws, are engaged in respective threaded holes that are positioned in alignment on both sides 15′, 15″ of the groove 20, level with each of the actuator means 19 body, in order to apply a predefined pressure on both sides of the actuator means 19.

For example, by screwing an adjusting means 34′ and unscrewing the corresponding adjusting means 34″ of the same extent, sliding of the respective actuator means 19 along the arrow shown in FIG. 3 can occur. By operating in the other way round, sliding in the opposite direction is obtained. This movement is allowed by the fact that the width of the actuator means 19 is less than the width of the groove 20. As the actuator means 19 slides as indicated above, the inclined upper surface 24 thereof acts as a wedge on the lower surface of the blade 7a, thus causing the portion of the blade 7a that corresponds to the said actuator means 7a to raise or to lower by elastic deformation, depending on which direction the actuator means 19 has been made to slide.

This action can be repeated with all the actuator means 19 mounted along the longitudinal groove 20, so that a thorough and punctual adjustment of the blade 7a can be obtained to correct any defect or corrugation and/or to mirror the defects of the non-adjustable rotary blade in the embodiment wherein only one blade support 10a is adjustable.

Even if this regulation system can be used also in the one-blade rotary drums, it is particularly useful when two or more blades are provided. In fact, if such blades are machined together, to assure perfect symmetry thereof, when a first blade 7a is adjusted as said before, the second blade 7b can be easily and rapidly regulated by applying the same sliding movement to corresponding actuator means 19 in the second blade support 10b.

It will be appreciated that only particular embodiments of the present invention have been described herein, to which those skilled in the art will be able to make any and all modifications necessary for its adjustment to specific applications, without however departing from the scope of protection of the present invention as defined in the annexed claims.

1-13. (canceled)

14. A cutting unit for cutting labels from a label film in labelling machines, comprising a rotary blade drum having at least one blade, and at least one blade support carrying a blade, and
a stationary blade assembly having a counter-blade, wherein
said at least one blade support comprises a plurality of independently-operated actuators, said actuators being positioned along the blade support for adjusting said blade, this adjustment being performed by raising or lowering corresponding portions of the blade through elastic deformation.

15. The cutting unit of claim 14, wherein each of said actuators is configured so as to apply a raising force on a base portion of said blade.

16. The cutting unit of claim 14, wherein said rotary blade drum comprises a rotary shaft, to which two blade supports are radially mounted, so that said blades are positioned along the periphery of the rotary blade drum, at opposed ends of a diameter of the drum.

17. The cutting unit of claims 14, wherein each of said blade supports comprises a body having a top end that is substantially C-shaped forming a longitudinal groove having two sides and a bottom, both said sides comprising an undercut and having at the side portion between such undercut and the edges of the sides slightly inclined surfaces with respect to the vertical, said inclined surfaces being substantially parallel.

18. The cutting unit of claim 17, wherein said actuators are positioned in a sliding arrangement along a transversal direction on the bottom of the longitudinal groove.

19. The cutting unit of claim 14, wherein each of said actuators has a substantially T-shaped section and comprises a base portion and a top portion that is narrower than the base portion, so that a shoulder is formed, said shoulder forming an inclined plane joining the top portion to the base portion.

20. The cutting unit of claim 17, wherein said actuators are positioned side-by-side in the groove, in such a way that the base portions thereof are in touch or are very close to each other, while the top portions are distanced; a plurality of pins being positioned in the longitudinal groove and transversally cross it between one actuator and another actuator, at a height such as to engage the surface of the shoulder of two adjacent actuators.

21. The cutting unit of claim 20, wherein fixed pins and floating pins are positioned in an alternate manner, said pins being inserted in corresponding through holes in both sides and being fixed with a predefined strength by pressing.

22. The cutting unit of claim 19, wherein the top portion of each of said actuators has an upper surface which is slightly inclined on a plane that forms, with the longitudinal vertical plane of the groove, a predefined angle of incidence different from 90°, the angle defining the inclination of said upper surface.

23. The cutting unit of claim 22, wherein said upper surface of each of said actuators forms angles of about 90° with said inclined surfaces of the sides.

24. The cutting unit of claim 19, wherein a slot-shaped through hole passes the body of each of said actuators from the top to the bottom and is aligned with a blind hole made in the bottom of the groove, the axis of said slot-shaped through hole being substantially perpendicular to the upper surface of each of said actuators.

25. The cutting unit of claim 24, wherein said at least one blade is laid on said plurality of actuators and is held by a plurality of fixing means that pass through the body of the blade and the slot-shaped through holes of the actuators and engage the threaded blind hole in the bottom of the groove.

26. The cutting unit of claim 25, wherein said fixing means are screws subject to a predetermined torque.
